(19) United States
(12) Patent Application Publication
(10) Pub. No.: US 2019/0073485 A1
(43) Pub. Date: Mar. 7, 2019

(54) Method to Process Different Files to Duplicate DDNAMEs

(71) Applicant: CA, INC., NEW YORK, NY (US)

(72) Inventors: FREDERIC DUMINY, St. Charles, IL (US); LINWOOD HUGH OVERBY, JR., Raleigh, NC (US); JOHN WILLIAM BAY, Warrenville, IL (US); DANIEL J. SHEA, Wheaton, IL (US)

(21) Appl. No.: 15/694,058

(22) Filed: Sep. 1, 2017

(51) Int. Cl. G06F 21/62; G06F 17/30

(52) U.S. Cl. CPC G06F 21/6218; G06F 17/3056; G06F 17/30168

(57) ABSTRACT

Inventive embodiments are directed to a system and methods that manage file access in an MVS file management system, which allows for the same name to be allocated to different files. When multiple files share the same name, the name of each file is modified in order to render those files unrecognizable to an operating system. Thereafter, one file may be purposefully provided with the “shared” name. When a computer process requests access to a file and specifies the shared name, the operating system locates the first instance of the shared name in the MVS file management system. As the other files are unrecognizable, the operating system locates the only instance of the shared name and the corresponding file that was purposefully provided with the shared name. The operating system provides the computer process with access to that particular file. The name shared by the unrecognizable files may be subsequently restored.

### BACKGROUND

An operating system (OS) run on a mainframe computer allocates a name to each dataset (i.e., a file) in a Multiple Virtual Storage (MVS) file management system comprising multiple virtual address spaces. At a high level, the operating system utilizes the allocated names of unique datasets in order to locate a desired dataset and pass control of the dataset to a utility application. In embodiments, the name is a data definition name, otherwise referred to as a DDNAME. A DDNAME is, generally, an eight-character alphanumeric designation.

When attempting to locate a desired dataset by using a DDNAME, an operating system locates the first instance or occurrence of the DDNAME in an address space and passes control to the requesting utility application. Once the first instance of the DDNAME is located, the operating system stops searching and disregards any other datasets that might have the same DDNAME.

### BRIEF SUMMARY

This summary is provided to introduce a selection of concepts in a simplified form that are further described below in the detailed description. This summary is not intended to identify key features or essential features of the claimed subject matter, nor should it be used as an aid in determining the scope of the claimed subject matter.

Inventive embodiments are directed to a system and methods that manage file access in an MVS file management system. Generally, an MVS file management system allows a file within an address space to be allocated more than one handle or “name” that can be used to call or locate the file. In the inventive embodiment herein, more than one instance of the same handle may be allocated within one address space. When the same handle is used more than once within one address space to point to one or more files, the handle is temporarily altered or modified in order to render those same handles from being recognized as duplicates to the operating system. Thereafter, the “shared” handle may be purposefully allocated to another file. When a computer process requests access to a file and specifies the shared name, the underlying operating system locates the first instance of the shared name in the MVS file management system. As the other shared names are unrecognizable, the underlying operating system locates the file that was purposefully provided with the shared name and provides the computer process with access to that file. The name originally shared by the unrecognizable files may be subsequently restored.

### BRIEF DESCRIPTION OF THE DRAWINGS

Inventive embodiments are described in detail below with reference to the attached drawing figures, wherein:

FIG. 1 is a block diagram showing a multiple virtual storage operating system, in accordance with an embodiment of the present disclosure;

FIG. 2 is a flow diagram showing a method for using duplicate data definitions in parallel processes, in accordance with embodiments of the present disclosure;

FIG. 3 is a flow diagram showing another method for using duplicate data definitions in parallel processes, in accordance with embodiments of the present disclosure; and

FIG. 4 is a flow diagram showing yet another method for using duplicate data definitions in parallel processes, in accordance with embodiments of the present disclosure.

### DETAILED DESCRIPTION

The subject matter of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to those described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. As used herein, the singular forms “a,” “an,” and “the” are intended to include the plural forms as well, unless the context clearly indicates otherwise.

As briefly introduced in the Background, an operating system (OS) (e.g., z/OS) of a mainframe computer allocates one or more handles to each dataset in the MVS file management system, which comprises multiple virtual address spaces (VAS s), a type of virtual memory. As used herein for simplicity, the terms “handle,” “identifier,” and “name” are used interchangeably to refer to identifiers for use in a data definition statement (i.e., “DD Statement”) to point or link to a physical dataset and perform read and/or write processes regarding a physical dataset. It will be understood from the present disclosure that the inventive embodiments are concerned with those identifiers used by the operating system to access physical datasets via DD Statements, and it will be understood that the true name of a physical dataset is not being modified. At a high level, virtual memory techniques use hardware and software to map virtual address spaces to physical address spaces in memory. The address spaces virtually store datasets in the MVS file management system. Generally, a physical dataset refers to a file. The operating system provides services for utility applications to be able to access the datasets which are maintained by the MVS file management system. The operating system utilizes the names allocated to the datasets in order to locate a desired dataset and pass control of the desired dataset to a utility application (e.g., in response to a DD Statement). Names may be randomly or arbitrarily allocated to datasets by the operating system, in embodiments. In some embodiments, the name is a data definition name, otherwise referred to as a DDNAME. It will be apparent to from this disclosure that “DDNAME” is an exemplary data definition handle used in a DD statement to call for a dataset that is associated with the DDNAME (e.g., the dataset was allocated the DDNAME). When an identifier is allocated to a dataset by the operating system, the name or identifier is, generally, an eight-character alphanumeric designation. In one embodiment, datasets are allocated one or more identifiers within an address space. The physical datasets are available to all the address spaces in the MVS file management system but each address space independently allocates identifiers to the datasets in its own. Generally, within each address space, the same identifier is not allocated more than once, whether for the same dataset or different datasets. Therefore, because each address space independently allocates identifiers to the datasets, an identifier may be concurrently allocated or in use in distinct address spaces but that identifier will not be allocated more than once within an individual address space. In other words, a duplicate identifier will not be allocated within an address space.

In MVS file management systems, an operating system functions to locate the first instance of a DDNAME in an address space and pass control of the dataset corresponding to the first instance of the DDNAME to a requesting utility application. Because the operating system locates the first instance of the DDNAME without exception, operating system allows only one instance of each DDNAME to be used during allocation within an individual address space. Once a particular DDNAME (e.g., random10) is assigned within an individual address space regarding a dataset, the same DDNAME will not be allocated within that individual address space to any other datasets. The restriction against using duplicate identifiers within an individual address space was designed to avoid the following outcome. Assume that multiple utility applications concurrently seek access (e.g., OPEN task in a thread) by calling for the same DDNAME within an address space, although each utility application actually desires access to different datasets. Because the different datasets are associated with the same DDNAME within the address space, the operating system locates the first instance of the DDNAME in the address space and provides access to the dataset that is associated with the first instance of the DDNAME, ignoring the other duplicate DDNAMES and associated datasets. Thus, all of the utility threads would be provided with access to the same dataset, although different datasets were ultimately desired by the utility applications. In such a scenario, the first instance of the DDNAME within the address space would be located, independent of whether the first instance of the DDNAME points to the desired dataset. As such, any later instance of the DDNAME within the address space would not be found by the operating system.

The inventive embodiments herein override the aforementioned restriction in MVS file management systems that prohibit the allocation of duplicate DDNAMES within one address space to datasets. The inventive embodiments herein also ensure that the operating system provides a utility application with access to the appropriate dataset when there are duplicate DDNAMES allocated within one address space. In accordance with the present disclosure, two or more processes can access different datasets, where the different datasets share the same DDNAME within an address space. It will be understood from the present disclosure that the inventive embodiments herein enable duplicate DDNAMEs to be used within each address space, and enable duplicate DDNAMEs within an individual address space to point to the same dataset or different datasets.

Accordingly, one embodiment of the present disclosure is directed to a method. In embodiments, the method comprises allocating a random name to a first dataset corresponding to an address space having access to a plurality of datasets. The method further comprises serializing processing of the plurality of datasets associated with the address space to a thread. The method continues by masking the target name of each dataset having the target name so an underlying operating system does not recognize each dataset as having the target name in embodiments. The method further comprises renaming the random name of the first data set to the target name. Upon receiving an open request specifying the target name, the method further comprises providing control of the first dataset having the target name to the open request, the first dataset being an only dataset of the plurality of datasets recognized by the underlying operating system as having the target name.

Another embodiment of the present disclosure is directed to a method. In embodiments, the method comprises allocating a random name to a first dataset, the first dataset corresponding to an address space having access to a plurality of datasets. The method further comprises serializing processing of the plurality of datasets associated with the address space to a thread. In embodiments, the method comprises identifying all of the datasets in the plurality of datasets that have the target name and masking the target name of the datasets so an underlying operating system does not recognize each dataset as having the target name. The method continues, in embodiments, by renaming the random name of the first dataset to the target name. In accordance with the method, an open request specifying the target name is intercepted. In response to intercepting the open request specifying the target name, the method comprises providing control of the first dataset having the target name to the open request, the first dataset being an only instance of the target name recognized by the underlying operating system. Upon processing the open request, the method comprises receiving control of the target name. The method continues by renaming the target name of the first dataset to the random name, in embodiments. The method further comprises, in embodiments, unmasking each dataset in the plurality so the underlying operating system recognizes each dataset as having the target name and releasing serialization of the plurality of datasets associated with the address space for the thread.

In yet another embodiment, the present disclosure is directed to a computerized system. In embodiments, the computerized system comprises a server including memory, the memory being partitioned into address spaces. The computerized system further comprises an operating system concurrently processing multiple threads, in embodiments. Each of the threads comprises processing tasks. For each of the threads, the operating system serializes processing of datasets associated with the address spaces to the threads, in embodiments. Generally, each one of the address spaces is serialized to one corresponding thread. The operating system identifies all datasets having a common name. Within each of the address spaces, the operating system masks each of the datasets identified as having the common name. In embodiments, the operating system allocates the common name to individual datasets within the address spaces. Within the address spaces, the operating system intercepts open requests that specify the common name, the open requests belonging to respective threads. Upon intercepting the open requests in the address spaces, the operating system invokes a process for the operating system to locate an occurrence of the common name, respectively, in each of the address spaces. In embodiments, the operating system provides control of the individual datasets having the common name to the open requests of respective threads. When providing control, each of the open requests is provided with the respective individual dataset having the common name in the respective address space serialized to the thread to which the open request belongs, each individual dataset being an only instance of the common name in the respective address space recognized by the operating system.

It will be understood from this disclosure that the discussion of modifying the allocated name associated with a dataset, changing a name associated with a dataset, or renaming a DDNAME of a dataset has been simplified for readability and comprehension.

As used herein, a utility application refers to a computer software program that operates to carry out tasks associated with datasets. Generally, a utility application is invoked using a computer programming language or scripting language such as, for example, Job Control Language (JCL). In some embodiments, a utility application is a computer software program written in a scripting language that, when executed or ‘run,’ performs batch processing of tasks in a run-time environment. Batch processing is performed automatically and without human intervention. Batch processing refers to multiple processes that are executed as a ‘batch’ of inputs or set of inputs.

In embodiments, utility applications may be invoked using commands in the scripting language and each command may utilize an identifier such as a name, to refer to a desired dataset. When a utility application is invoked, the identifier associated with the scripting language's command may be used by the operating system to locate and access a dataset that has been allocated a DDNAME that matches the identifier. For example, a “DD” statement in a computer programming language or scripting language statement such as JCL can be paired with a “DDNAME” to associate the DD statement action with a particular dataset having the matching identifier, as stored in a control block of an address space. One example of a DD statement is shown below. In the example, a DD statement “DSNAME” assigns the identifier or name of “ALPHA” to a specific dataset, which is identified using the dataset's memory location (unit and volume) in an address space:
//DD1 DD DSNAME=ALPHA,DISP=(,KEEP),
//UNIT=3391,VOLUME=SER=389989

Later DD statements may retrieve this data set by specifying ALPHA in the DSNAME parameter, unit information in the UNIT parameter, and volume information in the VOLUME parameter, for example. In embodiments using COBOL, for example, an identifier or name may be assigned to a specific dataset using an ASSIGN statement, and later SELECT ASSIGN statements may be used to retrieve that dataset having the identifier or name specified in the ASSIGN statement. It will be understood that the term “later” does not refer to temporal aspects (e.g., time or time of name allocation), but instead refers to the occurrence of the DDNAME as it is located or ‘found’ by the operating system when searching and scanning an address space to locate a particular DDNAME.

Continuing, as used herein, “thread” and “process” are terms that will be used interchangeably for simplicity. Generally, one thread comprises at least one smaller component or “task.” In embodiments, a thread includes multiple tasks. In an MVS file management system, multiple concurrent threads and their respective tasks are being processed. A task is a unit of work associated with a thread to which the task belongs. More specifically, in some embodiments, a task is a sequence of instructions treated by a control program as an element of work to be accomplished by a computer.

Tasks belonging to a thread share resources that are designated or allocated to that thread. For example, the tasks in one thread may share processing resources, storage memory, and an address space provided from an operating system to the thread to which the tasks belong, in some embodiments. In contrast, for example, an address space is not concurrently shared with more than one thread at any given time. This organization refers to “task owned storage” where a given task is provided with a particular task-related or job-related control block (CB) in the address space. Each address space control block (ASCB) comprises a range of virtual addresses and smaller, discrete control blocks, in some embodiments. Each task in a thread may be associated with a task-related control block within the address space control block associated with the thread, for example. For the purposes of simplicity, “address space” will be used herein to refer to an ASCB and/or to small control blocks therein. It will be understood, however, that threads are provided with an ASCB while individual tasks in a given thread are provided with smaller task-related control blocks within the designated ASCB.

Generally, an operating system provides a virtual address space to threads at a 1:1 ratio (i.e., one address space is made available to one thread). Thus, when a thread invokes a call that creates a copy of the thread, a separate address space is created or otherwise provided to the new copy of the thread. This copying aspect results in a familial hierarchy between threads. For example, when a thread executes a fork system call (e.g., in a Unix-type system) in order to create a new copy of itself, the new copy is a ‘child’ thread and the former process becomes a ‘parent’ thread. The parent thread and child thread, and their respective tasks, are provided with separate address spaces by the operating system.

At a high level, each task is performed with regard to a particular dataset. The task ‘points’ to the desired dataset using a DDNAME. In order to process a task in the thread, the operating system uses the DDNAME to provide the task with access to the desired dataset, which optimally is associated with the desired DDNAME. The operating system may concurrently process multiple tasks in one thread regarding an address space. Because of these concurrent tasks, the problems associated with duplicate DDNAMEs arose, as described above.

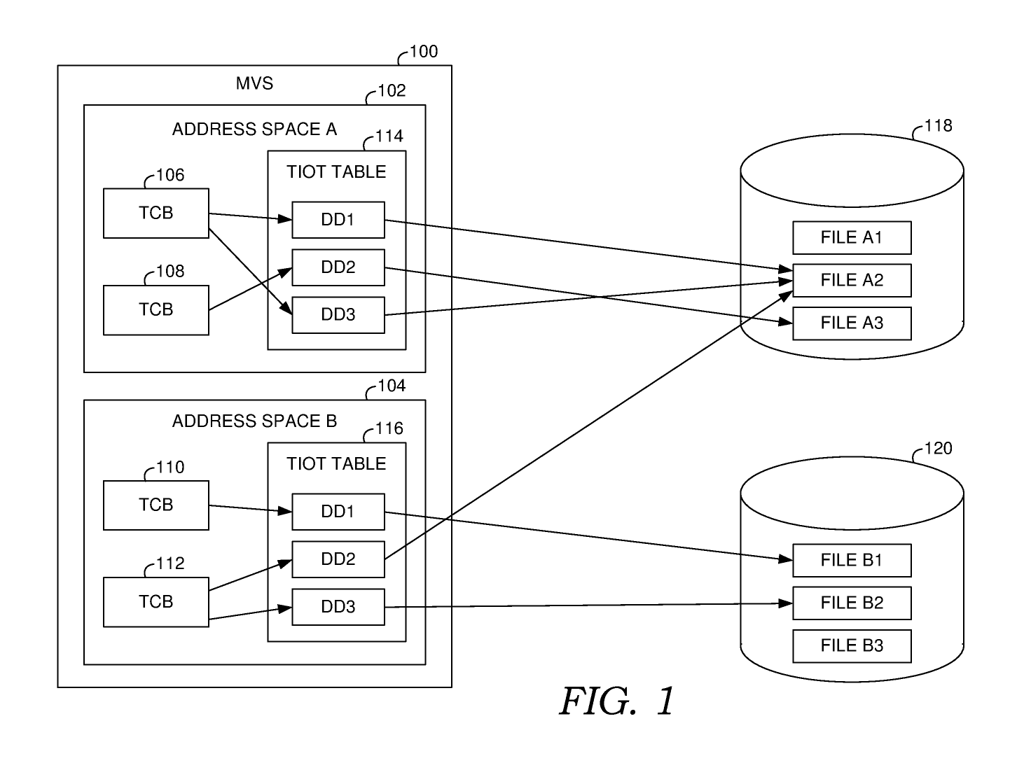

Beginning with exemplary FIG. 1, a block diagram is provided that illustrates a processing system 100. In some embodiments, the processing system 100 includes an MVS file management system. The processing system 100 may exist in a computing device, such as a mainframe-computing device, to implement programs including a run-time environment. The present disclosure enables parallel processes to access different datasets that have the same or duplicate data definition names, in accordance with an embodiment of the present disclosure. It should be understood that this and other arrangements described herein are set forth only as examples. Other arrangements and elements (e.g., machines, interfaces, functions, orders, and groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory. In various embodiments, the processing system 100 may be implemented via a single device or multiple devices cooperating in a distributed environment. It should be understood that the processing system 100 shown in FIG. 1 is an example of one suitable computing system architecture.

The components may communicate with each other via a network, which may include, without limitation, one or more local area networks (LANs) and/or wide area networks (WANs). Such networking environments are commonplace in offices, enterprise-wide computer networks, intranets, and the Internet. It should be understood that any number of datacenters, monitoring tools, or historical databases may be employed by the processing system 100 within the scope of the present disclosure. Each may comprise a single device or multiple devices cooperating in a distributed environment. For instance, the processing system 100 may be provided via multiple devices arranged in a distributed environment that collectively provide the functionality described herein. Additionally, other components not shown may also be included within the network environment.

The processing system 100 includes multiple address spaces, such as address spaces A and B, 102 and 104 respectively. The processing system 100 typically includes a plurality of address spaces, although two address spaces are presented in FIG. 1 for simplicity. The processing system 100 supports parallel processing of threads and tasks for those threads. For example, threads (i.e., thread control block or “TCB”) 106 and 108 are associated with address space A 102 and threads 110 and 112 are associated with address space B 104. Each address space includes a table or index of names for allocation to datasets within the corresponding address space. For example, address space A 102 includes task input/output (TIOT) table 114 and address space 104 includes TIOT table 116. When a dataset is allocated a name with regard to address space A 102, the name is obtained from TIOT table 114, for example. While the names are kept in the table of an address space, datasets are not located within the address spaces. Datasets are physically stored elsewhere. For example, datasets may be stored in direct access storage devices 118 and 120 having physical memory. At a high level, all of the address spaces have access to all of the datasets stored in the direct access storage devices 118 and 120. The datasets are allocated names from a TIOT table within an address space and the name points to a physical dataset. Within an address space, multiple names (e.g., DDNAMES) may point to the same dataset.

When thread 106 seeks to access a dataset, the thread 106 issues an OPEN request in address space A that specifies a target name such as DD1, for example. The target name DD1 points to a particular dataset, such as File A2 stored in direct access storage device 118. Thread 108 may issue an OPEN request in parallel to thread 106 within address space A by specifying a target name DD2, for example. The target name DD2 points to another dataset, such as filed A3 stored in direct access storage device 118. Continuing, thread 112 may concurrently seek to access a dataset by issuing an OPEN request in address space B that specifies a target name such as DD2 (allocated using TIOT table 116 within address space B), in embodiments. The target name DD2 points to a particular dataset, such as File A2 stored in direct access storage device 118. In this way, the underlying processing system uses the names in the tables that point to the datasets in order to provide threads with access to the datasets. Accordingly, tasks of threads are processed in parallel using allocated names within an address space to point to physical datasets. The names stored in tables (e.g., DD1, DD2, DD3) and used for processing tasks, as well as the filenames (e.g., File A1, A2, A3, B1, B2, B3) used for storing the datasets used in storage devices are examples only and are not limiting in any way.

In embodiments, the underlying processing system (e.g., z/OS) is an operating system capable of using various computer-programming languages, computing architectures, computing environments, software, and computing standards. Exemplary computer programming languages, computing architectures, computing environments, software, and computing standards include REXX, CLIST, SMP/E, JCL, TSO/E, ISPF, CICS, COBOL, IMS, DB2, RACF, SNA, WebSphere MQ, 64-bit Java, C, C++, and UNIX APIs.

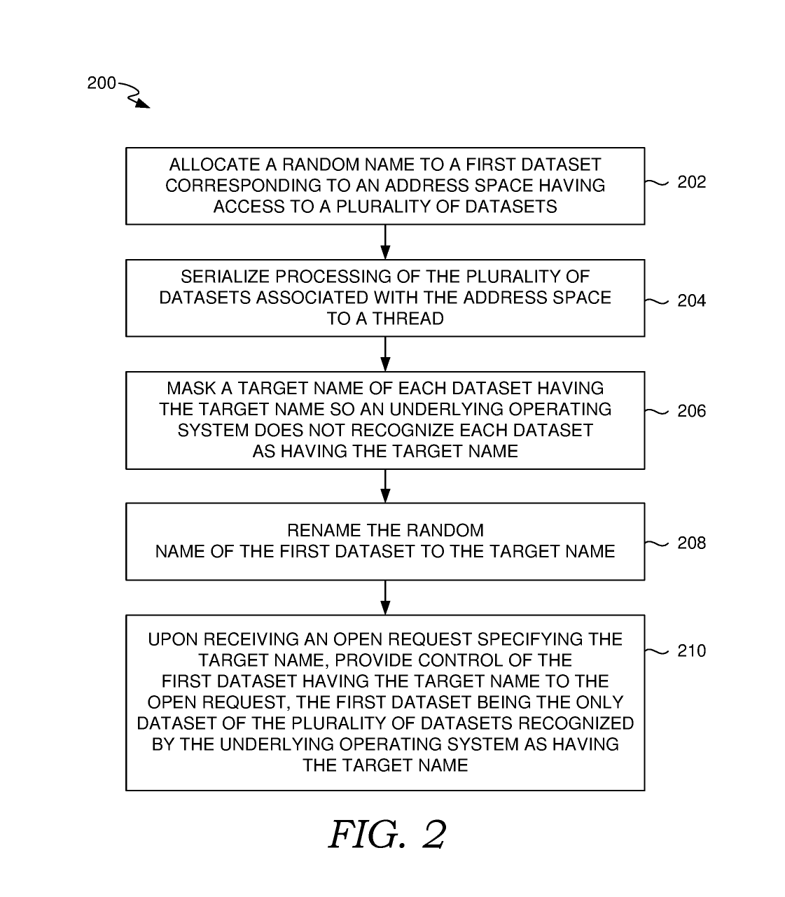

Turning now to FIG. 2, a flow diagram depicts a method 200, in accordance with embodiments of the present disclosure. In embodiments, the method 200 provides for using duplicate data definitions in parallel processes by masking unwanted duplicate data definitions within an address space. At block 202, the method 200 comprises allocating a random name to a first dataset corresponding to an address space having access to a plurality of datasets. In embodiments, the operating system operates in an MVS environment, which annotates datasets (e.g., files) by assigning an identifier or name to each one of the datasets. The identifier or name may be a DDNAME in embodiments. The operating system generates the identifier or name and allocates the identifier or name to a dataset. In some embodiments, the operating system generates values at random to serve as the identifier. In another embodiment, the operating system generates values to serve as the identifier using sequential values (e.g., alphanumeric characters) for each dataset and allocates the random value identifiers to each dataset. For example, the operating system generates a random DDNAME for each dataset, where the random DDNAME comprises any eight alphanumeric characters (e.g., SYSF0001, SYSF0002, 012345678, or A2YT78UM). The operating system allocates a random DDNAME to each dataset within one of the address spaces. More than one DDNAME may be allocated to an individual dataset. The operating system continues to allocate DDNAMEs for all of the datasets within the address space. In some embodiments, a command (e.g., ALLOCATE in JCL) is invoked and received by the operating system, and the operating system responds by allocating available DDNAMEs to the datasets within an address space that have not yet been allocated a DDNAME. It will be understood that, in other embodiments, identifiers or names may be allocated in environments that utilize less or more than eight characters, non-alphanumeric characters, and/or a mix of alphanumeric and non-alphanumeric characters, such that the use of a DDNAME in this description should not be construed as limiting.

In accordance with block 202 of the method 200, a random name is allocated to the first dataset. The first dataset is now associated with a random DDNAME, for example, and the first dataset can be located by the operating system by using the DDNAME in that address space to link to the first dataset. It will be understood that the use of “first,” “second,” and “later” with regard to the name allocation or dataset location is used to distinguish one dataset from another for the purpose of discussing the inventive embodiments, but the terms are not meant to be limiting as timing or relative locations in memory, for example.

At block 204, the method 200 performs serializing the processing of the plurality of datasets associated with the address space to a thread. The operating system performs serialization. The process of serialization locks the one address space to one thread, in embodiments. When the datasets within the address space are serialized to one thread, other threads cannot access the datasets via that address space. In this way, only one thread and its component tasks are provided with access to the datasets in the particular address space. Various serialization services (e.g., ISGENQ, ENQ/DEQ/RESERVE or Locking (SETLOCK macro)) are available in an MVS file management system in order to serialize the address space. In one embodiment, enqueuing is utilized for performing serialization. Enqueueing is a means by which a program running on z/OS may request control of a serially reusable resource, such as the datasets in the address space. Enqueueing may be employed using an ENQ (enqueue) macro, in some embodiments. Upon completion of serialization within the address space, the thread has exclusive control of the address space. It will be understood that enqueueing is performed in a very minute timeframe.

The serialization within an address space prevents concurrent threads with OPEN tasks that specify the same DDNAME from calling the same dataset within the same address space. Multiple threads can call OPEN tasks that specify the same DDNAME in other address spaces, however. This is because each address space has its own associated TIOT table with available DDNAMES. The serialization is performed within an address space so that other treads in the same address space cannot manipulate the TIOT table and associated DDNAME entries during current threads' method of ALLOCATION and OPEN of a desired file. Without serialization, parallel processing of tasks calling the same DDNAME would result in the operating system scanning a non-serialized address space, locating the first instance of the DDNAME and a corresponding dataset, and serve that one dataset to the different parallel processes calling the same DDNAME. With serialization of an address space, parallel processing of tasks is performed but masking duplicate DDNAMES ensures the operating system locates the only instance of the DDNAME and a corresponding dataset.

As the first dataset, having a randomly allocated name at this point, has been serialized along with all of the datasets in the address space, the method 200 continues at block 206 by masking duplicate occurrences of the target name Masking is performed to prevent the operating system from recognizing those duplicate occurrences of the target name in the address space. The TIOT control blocks in an address space are scanned or searched to locate the target name (e.g., two or more datasets that are both associated with or have duplicate DDNAMEs). As used herein a “target” name of DDNAME refers to a name that may be called by one or more tasks of the thread serialized to the address space.

Masking is performed by replacing or substituting a value in the name associated with a dataset, where that value modifies the name so that the name no longer matches the target name. For example, because an operating system parses DDNAMEs when searching for a first instance of a DDNAME, substituting one of the eight alphanumeric characters of a duplicate DDNAME with a non-alphanumeric value will mask the DDNAME from the operating system. In other words, the non-alphanumeric value is not capable of being parsed, and the DDNAME is no longer visible to the operating system.

In an embodiment that employs DDNAMEs, the substitution of a non-alphanumeric character or value (e.g., a hex box □ or wildcard character) is sufficient to render the identifier or name associated with a dataset unrecognizable by the operating system scanning the serialized address space for a particular identifier or name. For example, the name “SFSY0001” may be masked using any of the following substitutions: □FSY0001, S□SY0001, SF□Y0001, SFS□0001, SFSY□001, SFSY0□01, SFSY00□1, and SFSY000□. Accordingly, any one of the alphanumeric characters in a name may be substituted or replaced with a non-alphanumeric character when masking is performed. In further embodiments, more than one of the alphanumeric characters in the name is substituted or replaced with a non-alphanumeric character (e.g., SF□Y00□1). However, it will be understood that, because allocated names may utilize less or more than eight characters, non-alphanumeric characters, and/or a mix of alphanumeric and non-alphanumeric characters in other embodiments, the masking aspect may substitute one or more values, add one or more values, or remove one or more characters or values so that an allocated name is masked and is no longer recognizable by an operating system. Additionally, the value to be replaced may be chosen at random, or selectively chosen by the operating system. In further embodiments, a particular value (e.g., a first value in an identifier, a last value in the identifier, a numeral instead of a letter) may be selectively chosen over other values in the identifier for replacement, as the value may be easier to locate for subsequent unmasking, as will be described hereinafter.

Because the first dataset was allocated a random name at block 202, the first dataset is not masked, in contrast to the other datasets that now bear masked names. The method 200 continues by renaming the random name of the first dataset, as shown at block 208. The random name that has been allocated to the first dataset is changed to the target name in accordance with the method 200. As such, the random name of the first dataset is changed to the target DDNAME, in embodiments. At this point, the first dataset is the only dataset in the address space that is associated with the target name. As such, upon receiving an open request specifying the target name, as shown at block 210, the method 200 provides control of the first dataset, as associated with the target name, to the open request because the first dataset is the only dataset of the plurality of datasets recognized by the underlying operating system as being associated with the target name. An open request, generally, corresponds to a DD statement instruction seeking access to a particular dataset to be used in performing a task for a thread. In embodiments, when an open request is received that specifies the target name, an intercept for the first dataset is set up. The intercept establishes a control point. When the open request is invoked for the performance of a task in a thread and the open request calls the target DDNAME, control of the target DDNAME is obtained by the thread and corresponding utility application.

Using the method 200, the operating system's behavior of locating and providing access to the first instance of a DDNAME, independent of the thread, is controlled and exploited to ensure that a desired first dataset is located and accessed by a thread even when duplicate DDNAMEs have been allocated within one address space. Using the method 200 explained above, each of a plurality of concurrently processing threads serialized to different address spaces may be provided access, via the operating system, to datasets that share the same DDNAME. Moreover, within one address space, duplicate DDNAMEs may be allocated to datasets by the operating system because the operating system does not recognize or “see” the masked duplicate DDNAMEs in the serialized address space. Therefore, when the thread calls for a particular DDNAME in the serialized address space, the first and only instance of the DDNAME is located in the serialized address space and the DDNAME corresponds to one desired dataset.

When control of the target DDNAME has been obtained by the thread and corresponding utility application, access to the first dataset having the target DDNAME is provided to the task and thread and the first dataset becomes associated with the thread responsible for the task. The target DDNAME is not essential to the task once the association or “affinity” is created between the first dataset and the thread in the serialized address space. In contrast, an association or affinity is not created between the target name and the one thread. As this association or affinity is created, the open request is complete. When the open request is complete, control of the target DDNAME may be passed from the task to the intercept that was set up when the open request was received and/or invoked.

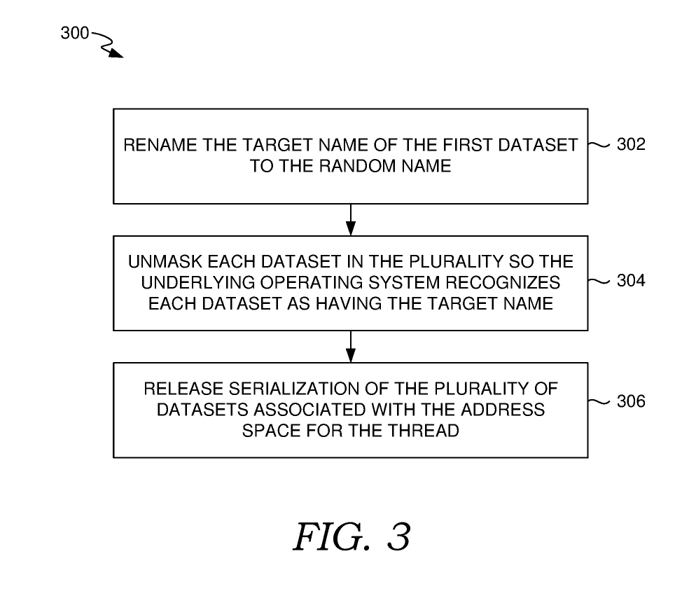

Once the affinity between the thread and the first dataset is established, the target name is not essential and the target name may be placed back into circulation for allocation in the address space by the operating system. FIG. 3 presents a flow diagram showing a method 300 for this purpose, in accordance with embodiments of the present disclosure. Generally, the method 300 enables the allocation of duplicate data definitions within an address space as the method 300 unmasks duplicate data definitions for reallocation within an address space. The method 300 renames the target name of the first dataset to the random name, shown at block 302. As an association or affinity now exists between the first dataset and the thread, as discussed above, the name allocated to the first dataset may be changed or modified without creating problems. Continuing at block 304, the method 300 comprises unmasking the target name associated with each dataset in the plurality so the underlying operating system recognizes the target name. The masked target name includes at least one value that is unrecognized by the operating system when the operating system is scanning for a first instance of a DDNAME within a serialized address space. The one or more unrecognizable values in the masked target name are reset or restored to a recognizable value, such as their original value(s). In some embodiments, the masked names associated with datasets are unmasked or otherwise renamed to reflect the originally allocated name (e.g., a target DDNAME). Because unmasking restores the names of the datasets to recognizable values, the operating system can recognize or can resume “seeing” all of the previously masked names again. At block 306, the method performs releasing serialization of the plurality of datasets associated with the address space for the thread. When serialization of the address space to the thread has been released, other threads and respective tasks may access the address space and continue with normal processing.

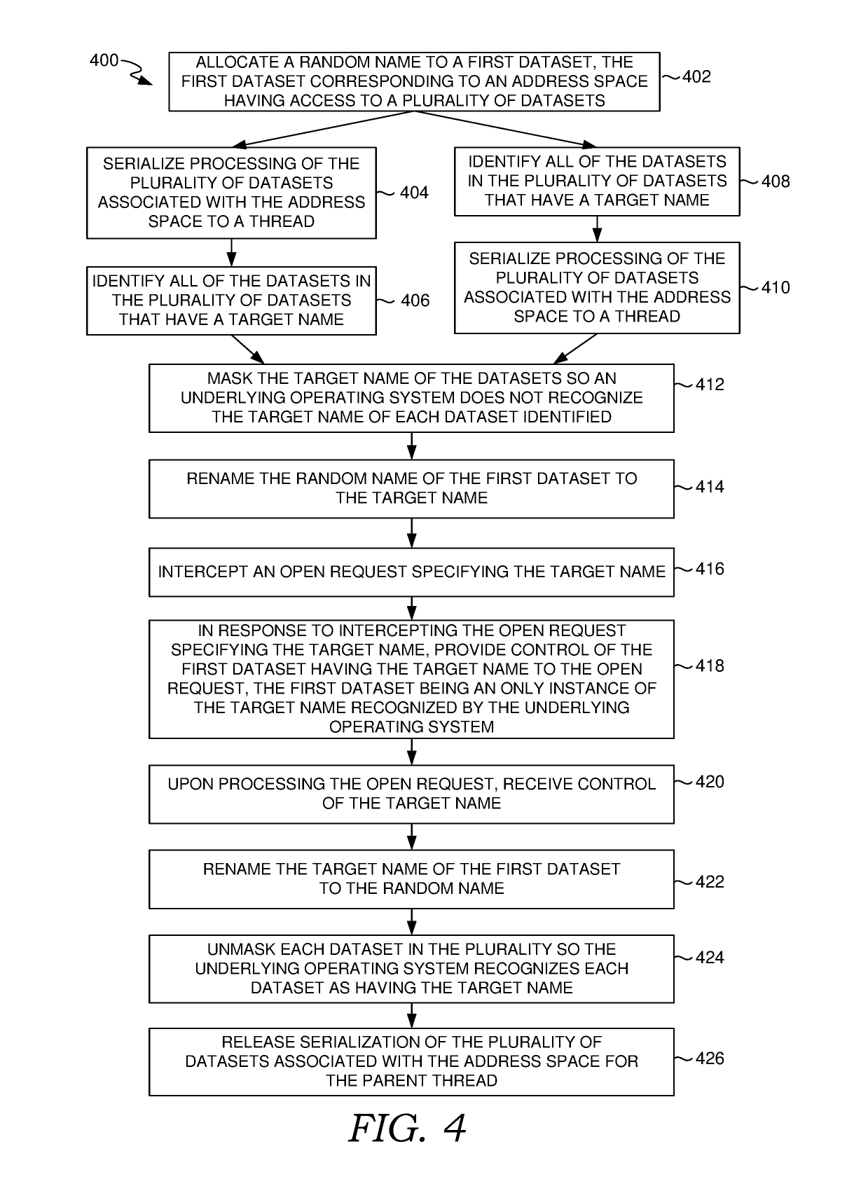

FIG. 4 is a flow diagram showing a method 400, in accordance with embodiments of the present disclosure. In embodiments, the method 400 provides for using duplicate data definitions within an address space by masking and then unmasking duplicate names associated with datasets therein. The method 400 is similar to those methods previously discussed, and as such, the method 400 is discussed briefly. In accordance with the method 400, a random name is allocated to a first dataset, the first dataset corresponding to an address space having access to a plurality of datasets, as shown at block 402. The method 400 further comprises serializing processing of the plurality of datasets associated with the address space to a thread, as shown at block 404. In embodiments, the method 400 comprises identifying all of the datasets in the plurality of datasets that have the target name, as shown at block 406. In this way, duplicate target names allocated within the address space are identified.

In an alternative embodiment, the method 400 performs identifying all of the datasets in the plurality of datasets that have the target name, as shown at block 408. In this way, duplicate target names that have been allocated within the address space are identified. In such an alternative embodiment, the method 400 comprises serializing processing of the plurality of datasets associated with the address space to a thread, as shown at block 410, subsequent to identifying all of the datasets in the plurality of datasets that have the target name.

The method 400 continues by masking the target name of the datasets so an underlying operating system does not recognize each dataset as having the target name, shown at block 412. As the underlying operating system cannot recognize the masked target name, the underlying operation system cannot locate those datasets associated with the masked target name. At block 414, the method 400 comprises renaming the random name of the first dataset to the target name. In accordance with the method 400, an open request specifying the target name is intercepted, shown at block 416. At block 418, the method 400 comprises providing control of the first dataset having the target name to the open request in response to intercepting the open request specifying the target name. In embodiments, the only instance of the target name in the address space points to the first dataset and that single instance of the target name is recognized by the underlying operating system due to the masking performed at block 412 of the method 400. An association or affinity is created between the first dataset and the thread to which the task, having invoked an open request, belongs. When this association or affinity is created, the open request is complete and the task has access to the first dataset.

Upon processing the open request, the method 400 comprises receiving control of the target name, at block 420. The target name or target DDNAME is not essential to the task once the association or affinity is created between the first dataset and the thread. The method 400 continues at block 422 by renaming the target name of the first dataset to the random name, in embodiments. The method further comprises, at block 424, unmasking each dataset in the plurality so the underlying operating system recognizes each dataset as having the target name. The method comprises releasing serialization of the plurality of datasets associated with the address space for the thread, shown at block 426.

As can be understood, embodiments of the present disclosure provide for an objective approach for enabling an address space and operating system to process a data object in common storage. The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method comprising:
allocating a random name to a first dataset corresponding to an address space having access to a plurality of datasets;
serializing processing of the plurality of datasets associated with the address space to a thread;
masking a target name of each dataset having the target name so an underlying operating system does not recognize each dataset as having the target name;
renaming the random name of the first dataset to the target name; and
upon receiving open request specifying the target name, providing control of the first dataset having the target name to the open request, the first dataset being an only dataset of the plurality of datasets recognized by the underlying operating system as having the target name.

2. The method of claim 1, further comprising:
upon providing control of the first dataset having the target name to the open request, creating an affinity between the first dataset and the thread corresponding to the open request.

3. The method of claim 2, further comprising:
upon creating the affinity between the first dataset and the thread corresponding to the open request, retrieving control of the target name.

4. The method of claim 1, further comprising:
subsequent to providing control of the first dataset having the target name to the open request, renaming the target name of the first dataset to the random name;
unmasking each dataset in the plurality so the underlying operating system recognizes each dataset as having the target name; and
releasing serialization of the plurality of datasets associated with the address space.

5. The method of claim 1, further comprising:
identifying, in the address space, each dataset in the plurality having the target name and comprising different data.

6. The method of claim 5, wherein masking further comprises:
changing a value of the target name for each dataset in the plurality having the target name, wherein the value is changed to a non-alphanumeric value that makes each dataset unrecognizable as having the target name by the underlying operating system of the address space.

7. The method of claim 1, wherein serializing processing of the plurality of datasets to the thread prevents other threads from accessing the plurality of datasets.

8. The method of claim 1, wherein the method is performed in tandem for a plurality of different address spaces.

9. The method of claim 1, wherein upon providing control of the first dataset having the target name to the open request, the first dataset having the target name is not accessible to other threads.

10. The method of claim 1, wherein upon masking the target name so the underlying operating system does not recognize each dataset as having the target name and renaming the random name of the first dataset to the target name, the first dataset associated with the target name is the only occurrence of the target name in the plurality of datasets in the address space.

11. A method comprising:
allocating a random name to a first dataset, the first dataset corresponding to an address space having access to a plurality of datasets;
serializing processing of the plurality of datasets associated with the address space to a thread;
identifying all of the datasets in the plurality of datasets that have a target name;
masking the target name of the datasets so an underlying operating system does not recognize each dataset as having the target name;
renaming the random name of the first dataset to the target name;
intercepting an open request specifying the target name;
in response to intercepting the open request specifying the target name, providing control of the first dataset having the target name to the open request, the first dataset being an only instance of the target name recognized by the underlying operating system;
upon processing the open request, receiving control of the target name;
renaming the target name of the first dataset to the random name;
unmasking each dataset in the plurality so the underlying operating system recognizes each dataset as having the target name; and
releasing serialization of the plurality of datasets associated with the address space for the thread.

12. The method of claim 11, further comprising creating a control point for intercepting the open request.

13. The method of claim 12, further comprising, upon intercepting the open request specifying the target name at the control point, invoking a process for the underlying operating system to locate an occurrence of the target name in the plurality of datasets.

14. The method of claim 11, wherein upon providing control of the first dataset having the target name to the open request, the method comprises:
creating an affinity between the first dataset and the thread corresponding to the open request.

15. The method of claim 14, further comprising, upon creating the affinity between the first dataset and the thread including the open request, recognizing that processing of the open request is complete.

16. The method of claim 11, wherein an n-queue is used when serializing the plurality of datasets associated with the address space including the first dataset to the thread, and wherein the n-queue creates exclusive access to the plurality of datasets for the thread.

17. The method of claim 11, further comprising:
identifying duplicate names in the plurality of datasets.

18. The method of claim 11, further comprising:
in a second address space, performed in tandem with the method in the first address space:
serializing processing of a plurality of datasets corresponding to the second address space to a second thread;
identifying all datasets in the plurality of datasets associated with the second address space that have the target name, wherein the target name is the same in the second address space and the first address space;
masking the target name in the second address space so an underlying operating system does not recognize each dataset as having the target name;
renaming the random name of the second dataset to the target name;
intercepting a second open request specifying the target name, the second open request belonging to the second thread; and
providing control of the second dataset having the target name to the second open request, the second dataset being an only instance of the target name in the second address space recognized by the underlying operating system.

19. The method of claim 11, wherein the random name and the target name are data definition names (DDNAME), and wherein the thread is a target control block in a multiple virtual storage system.

20. A computerized system comprising:
a server including memory, the memory being partitioned into address spaces; and
an operating system concurrently processing multiple threads, each of the threads comprising processing tasks, wherein for each of the threads, the operating system:
serializes processing of datasets associated with the address spaces to the threads, wherein each one of the address spaces is serialized to one corresponding thread;
identifies all datasets having a common name;
within each of the address spaces, masks each of the datasets identified as having the common name;
allocates the common name to individual datasets within the address spaces;
within the address spaces, intercepts open requests that specify the common name, the open requests belonging to respective threads;
upon intercepting the open requests in the address spaces, invokes a process for the operating system to locate an occurrence of the common name, respectively, in each of the address spaces; and
provides control of the individual datasets having the common name to the open requests of respective threads, wherein each of the open requests is provided with the respective individual dataset having the common name in the respective address space serialized to the thread to which the open request belongs, each individual dataset being an only instance of the common name in the respective address space recognized by the operating system.
